(19) United States
(12) Patent Application Publication
(10) Pub. No.: US 2012/0286527 A1
(43) Pub. Date: Nov. 15, 2012

(54) ADJUSTABLE STRIKE PLATE

(75) Inventors: William Mullet, Sugarcreek, OH (US); Mihai F. Cotlet, Dover, OH (US)

(73) Assignee: PROVIA DOOR, INC., Sugarcreek, OH (US)

(21) Appl. No.: 13/104,089

(22) Filed: May 10, 2011

(51) Int. Cl. E05B 15/02

(52) U.S. Cl. 292/341.18

(57) ABSTRACT

An adjustable strike plate assembly for a door including a first member having a first aperture and a second member having a second aperture. The interior surface of the second member abuts the exterior surface of the first member and the first and second apertures at least partially overlap to define a strike hole through which a handset latch is received. A flange extending outwardly from the interior surface of the first member adjacent the first aperture is received within a mortise hole in the door jamb. The flange guides the latch into the hole. The second member includes a curved lip that extends outwardly from the interior surface thereof and into selective engagement with one of a plurality of grooves on the exterior surface of the first member. The first member is movable relative to the second member to adjust the dimensions and location of the strike hole.

### BACKGROUND OF THE INVENTION

1. Technical Field

This invention relates generally to handsets or locksets used on doors. More particularly, this invention relates to strike plates used to engage latches or locking bolts that extend from handsets. Specifically, this invention relates to a strike plate that is adjustable to engage latches or locking bolts made by different manufacturers or latches that extend outwardly from doors of different thicknesses.

2. Background Information

Strike plates are protective metal plates that are mounted onto a door frame to engage a latch or bolt which extends outwardly from a handset or lockset when the door is closed. One of the issues experienced in the installation of strike plates is that the latch or bolt extending from the door may not be able to be properly aligned with the strike hole in the strike plate. This typically occurs if the lockset is replacing a previously installed lockset and the new hardware does not have the same dimensions as the old hardware. It can also occur if the new hardware is made by a different manufacturer from the one who made the old hardware. There may also be installation problems if the door itself is changed and the thickness of the new door differs from the previously installed door. Whatever the cause, the misalignment between the latch or bolt and the strike hole can result in the door being prevented from adequately latching or locking in the door frame.

This issue has been somewhat addressed in the prior art in the provision of adjustable strike plates. For example, U.S. Pat. No. 7,011,348 issued to Milo discloses an adjustable strike plate. The strike plate includes a planar member having one or more walls that extend outwardly from the periphery of the planar member and substantially at right angles thereto. The planar member and walls define a cavity that is accessible through an aperture in the planar member. One or more insert plates are engaged in the walls to change the size and/or position of the aperture. Each of the walls includes a series of grooves that extend generally perpendicular to the interior surface of the planar member. The edges of the insert plates are received in these grooves so that the plates are retained at right angles to the interior surface. Additionally, the insert plates themselves include a series of grooves that are disposed at right angles to the interior surface of the planar member when the insert plates are engaged with the walls. The edges of additional insert plates may be engaged in the grooves of the insert plates and the walls. Thus, the insert plates can be inserted or removed to change the length and/or width of the aperture or to thereby effectively shift the position of the aperture in the planar member. A rear cover is engaged with the walls to enclose the insert plates between the planar member and the cover. The rear cover is placed in abutting contact with the door jamb when the strike plate is engaged in the door frame.

U.S. Pat. No. 4,171,836 issued to St. Aubin discloses a second type of adjustable strike plate. In this instance, a strike plate assembly is provided that includes a U-shaped strike plate and a U-shaped security plate that are interlockingly engaged with each other. The strike plate is a generally planar member that has first and second legs spaced vertically apart from each other and connected together by an intermediary region. The first and second legs are parallel to each other and the intermediary region is disposed between the first and second legs but is offset relative thereto so that an opening is defined between the first and second legs. Each of the first and second legs includes an elongate slot therein and is provided with a plurality of grooves on an exterior surface surrounding the slot. The grooves are oriented at right angles to the direction of elongation of the slots. The intermediary region terminates with a curved lip similar to that customarily provided on strike plates as the first contact point with a latch or locking bolt. The security plate of the assembly includes first and second legs disposed a spaced distance horizontally apart from each other so that a separate wooden jamb section of the door frame is able to be received between them. The jamb section defines a strike hole into which the latch or bolt will be received after passing through the strike plate assembly. Each of the first and second legs of the security plate defines an opening that will align with each other and with the strike hole in the jamb section. The first leg of the security plate is of a smaller dimension than the second leg thereof and is provided with a plurality of grooves on its interior surface. These grooves are configured to mate with the grooves on the strike plate. The strike plate and security plate are engaged by sliding the lip of the strike plate through the opening in the first leg of the security plate. The security plate is then engaged with the door jamb and fasteners are loosely received through aligned holes in the strike plate, security plate and the door jamb. The strike plate is then moved horizontally relative to the security plate so that the desired size opening is created to receive the latch or bolt from the door. The interlocking grooves on the exterior surface of the strike plate and the interior surface of the security plate hold the two plates in the desired position until the screws are tightened. The door jamb is then secured to the rest of the door frame. If it is desired to adjust the size of the opening, the screws have to be loosened to a sufficient degree to permit the strike plate to be slid horizontally relative to the security plate. Since the security plate overlays the strike plate and since there are a plurality of grooves on both of the strike plate and the security plate, the adjustment only becomes possible if the fasteners are significantly loosened as the numerous grooves have to be repeatedly disengaged from each other to make the adjustment. Loosening screws is problematic as it reduces the strength of the engagement between the components and therefore effectively reduces the security provided by the inclusion of the security plate. Additionally, the degree to which adjustment is possible is quite restricted in that only the strike plate of the assembly can be moved. The security plate has to snugly engage the edge of the door jamb section and cannot be moved in a first direction outwardly away from the door jamb section as it would then project beyond the edge of the door jamb. Obviously, moving the security plate in the opposite direction is impossible because the door jamb section will prevent this movement.

There is therefore a need in the art for an improved adjustable strike plate that permits relatively easy adjustment of the size and location of the strike hole for receiving a latch or bolt from a handset or lockset therethrough.

### BRIEF SUMMARY OF THE INVENTION

The device of the present invention is an adjustable strike plate assembly for a door which includes a first member having a first aperture and a second member having a second aperture. The interior surface of the second member abuts the exterior surface of the first member and the first and second apertures at least partially overlap to define a strike hole through which a handset latch is received. A flange extending outwardly from the interior surface of the first member adjacent the first aperture is received within a mortise hole in the door jamb. The flange guides the latch into the hole. The second member includes a curved lip that extends outwardly from the interior surface thereof and into selective engagement with one of a plurality of grooves on the exterior surface of the first member. The first member is movable relative to the second member to adjust the dimensions and location of the strike hole.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a front elevational view of a door incorporating the adjustable strike plate of the present invention;

FIG. 2 is a perspective view of a portion of the door jamb and of the adjustable strike plate in accordance with the present invention;

FIG. 3 is an exploded perspective view of the strike plate and the door jamb;

FIG. 4 is a top cross-sectional view of the strike plate and door jamb taken through line 4-4- of FIG. 2, and showing the strike plate in a first position;

FIG. 5 is an enlarged top view of the highlighted region of FIG. 4;

FIG. 6 is a top cross-sectional view of the strike plate and door jamb taken through line 4-4- of FIG. 2, and showing the strike plate in a second position; and

FIG. 7 is a top cross-sectional view of the strike plate and door jamb taken through line 4-4- of FIG. 2, and showing the strike plate in a third position. Similar numbers refer to similar parts throughout the drawings.

### DETAILED DESCRIPTION OF THE INVENTION

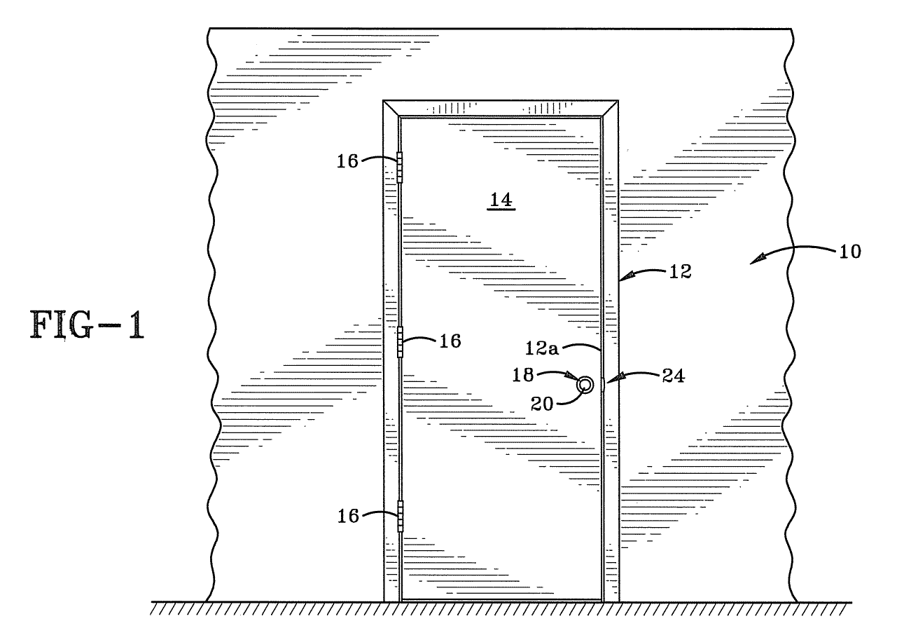

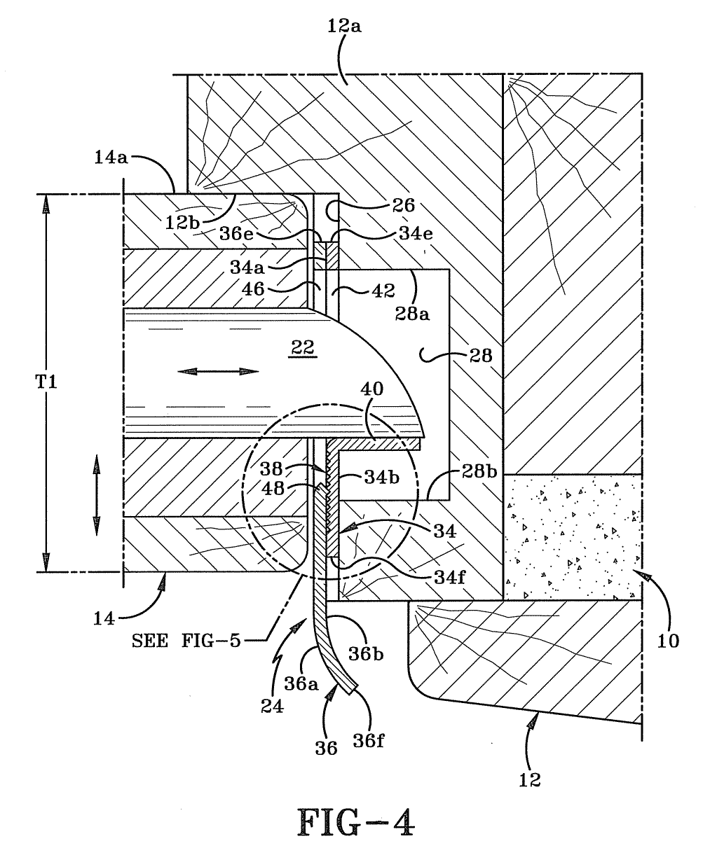

Referring to FIG. 1 there is shown a wall 10 into which a door opening has been made and surrounded by a door frame 12. A door 14 is mounted into frame 12 by way of a plurality of hinges 16 that allow door 14 to swing open and closed. A handset or lockset 18 is provided to aid a user in opening, closing and locking door 14 to frame 12. The terms “handset” and “latch” will be used hereinafter to refer to any type of assembly that includes one or more door knobs 20 and a latch 22 (FIG. 4) or locking bolt that extends outwardly from the door. Furthermore, it will be understood that door 14 may include handles instead of or as well as door knob 20, and locking bolts instead of or as well as latch 22.

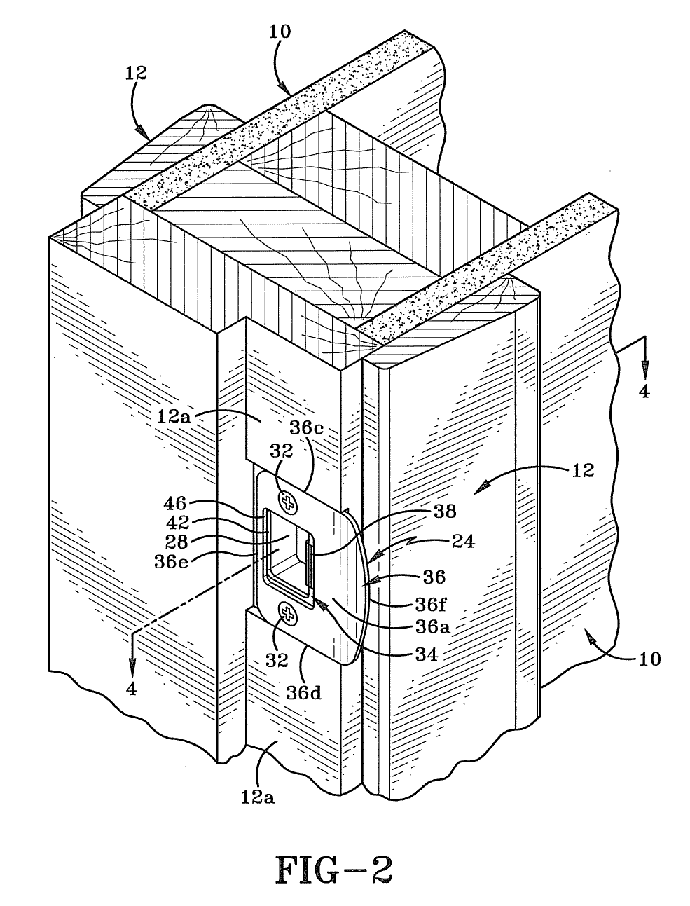

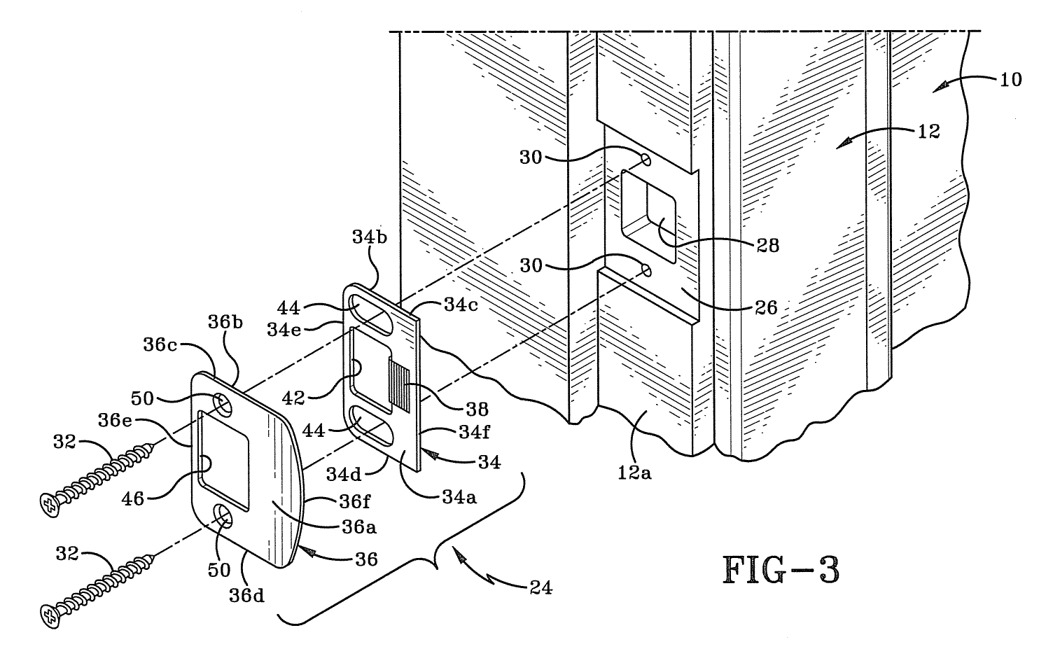

FIGS. 2 and 3 show a strike plate assembly 24 in accordance with the present invention mounted to a door jamb 12a that forms part of door frame 12. A mortise 26 is cut into jamb 12a so that when strike plate assembly 24 is mounted to jamb 12a, the exterior surface thereof will be substantially flush with the exterior surface of jamb 12a. A strike hole 28 is cut into mortise 26 to receive latch 22 therein when door 14 is closed. Additionally, one or more screw holes 30 are drilled into mortise 26 to receive fasteners 32 for securing strike plate assembly 24 to jamb 12a.

In accordance with a specific feature of the present invention, strike plate assembly 24 comprises two independent members that are able to be moved relative to each other to vary the size of an opening within the strike plate assembly 24. It should be understood that both of the two members are able to be moved in both of a first and a second direction, i.e., toward and away from each other, in order to adjust the size of the opening in the assembly 24. This adjustability of strike plate assembly 24 makes it possible for the installer to install differing makes and models of handset 18 to door 14 and still have the latch 22 thereof positively engage in mortise hole 28. Additionally, the installer is able to install the handset 18 and strike plate assembly 24 on doors of differing thicknesses. It is this last situation that is illustrated in the attached figures. Preferably, strike plate assembly 24 is manufactured from brass or stainless steel but other suitable materials may be used instead.

In accordance with the present invention, strike plate assembly 24 comprises a first member and a second member. First member of strike plate assembly 24 is shown in detail in FIGS. 3-7 and is indicated by the reference character 34. The second member of strike plate assembly 24 is shown in the same figures and is indicated by the reference character 36. First member 34 is disposed to abut the exterior surface of door jamb 12a and is specifically disposed to abut the exterior surface of mortise 26. Second member 36 is disposed to abut the exterior surface of first member 34 and to overlap the same.

First member 34 is a planar member that has an exterior surface 34a, an interior surface 34b, a top edge 34c, a bottom edge 34d, a left side edge 34e and a right side edge 34f. It will be understood that the terminology referring to the interior surface, exterior surface, top, bottom and left and right side edges of the first member 34 are used specifically with reference to the figures attached hereto and should not be construed as limiting the positioning or orientation of strike plate assembly 24. It will be understood by those skilled in the art that the strike plate assembly 24 in accordance with the invention can be installed in any orientation suitable for the type of door that is being secured to a frame or wall surrounding the door. Preferably, first member 34 is generally rectangular in shape although other shapes are possible.

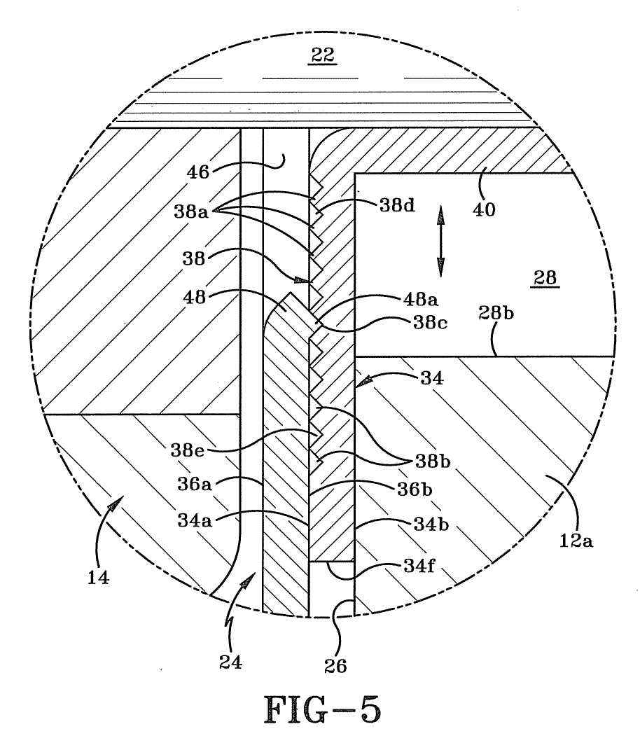

Exterior and interior surfaces 34a, 34b are both substantially planar in nature and are substantially parallel to each other. None of the top, bottom, left side or right side edges 34c-34f is curved out of alignment with exterior and interior surfaces 34a, 34b. In other words, first member 34 is essentially flat with the exception of a plurality of parallel grooves 38 provided on exterior surface 34a and a flange 40 that extends outwardly away from interior surface 34b. An aperture 42 is defined in first member 34 and extends between exterior and interior surfaces 34a, 34b thereof. Preferably, the series of grooves 38 are provided on a region of exterior surface that is adjacent one side of aperture 42. Grooves 38 extend in a direction that is parallel to the longitudinal axis of first member 34, where that longitudinal axis extends through top and bottom edges 34c, 34d and generally at right angles thereto. As is shown in FIG. 5 grooves 38 comprise a plurality of alternating peaks 38a and valleys 38b. The size of each peak and valley can vary but a suitable size for the purpose described herein is about 0.015 inches in height and depth. The length of each groove 38 from a top end thereof (spaced from top edge 34c) to a bottom end thereof (spaced from bottom edge 34d) is around 0.770 inches.

A pair of spaced apart elongated slots 44 is defined in first member 34. Slots 44 are positioned so that aperture 42 is defined in a region between the two slots 44. Each slot 44 is elongated in a direction disposed at right angles to the longitudinal axis of first member 34. Slots 44 are configured so that at least a region thereof will be alignable with screw holes 30 when first member 34 is placed into mortise 26.

Flange 40 comprises at least a section of the material that is removed from first member 34 to create aperture 42. Flange 40 originates adjacent one side of aperture 42 and extends outwardly from interior surface 34b and is disposed generally at right angles to that surface. When interior surface 34b of first member 34 is placed in abutting contact with the mortise 26 in door jamb 12a, flange 40 extends for a distance into mortise hole 28. Flange 40 may be of any suitable length but in a first embodiment of the invention it is around 0.665 inches long.

Referring to FIGS. 3 and 4, second member 36 has an exterior surface 36a, an interior surface 36b, a top edge 36c, a bottom edge 36d, a left side edge 36e and a right side edge 36f. As is evident from the front perspective view of the second member 36 shown in FIG. 3, right side edge 36f is curved along its length as measured from top edge 36c to bottom edge 36d. The radius of at both the top end and the bottom end of right side edge 36f preferably is around 0.25 inches while the radius of curvature of the portion intermediate the top and bottom ends preferably is around 2.750 inches. Additionally, as is evident from FIG. 4, right side edge 36f has a convexly curved profile when viewed in cross-section. In particular, right side edge 36f is convexly curved in a direction from exterior surface 36a toward interior surface 36b. When second member 36 is viewed from above as in FIG. 4, it can be seen that the curved right side edge 36f extends rearwardly toward door jamb 12a. Left side edge 36e is not curved. When strike plate assembly 24 is mounted on door frame 12, right side edge 36f curves over the edge of door jamb 12a and serves two purposes. Firstly, it protects the corner of the jamb 12a from being damaged by latch 22 and, secondly, it guides latch 22 toward mortise hole 28.

An aperture 46 is defined in second member 36 and extends from exterior surface 36a through to interior surface 36b thereof. Aperture 46 is sized to at least partially align with aperture 42 in first member 34 and mortise hole 28 when strike plate assembly 24 is installed on door jamb 12a. A portion of the second member 36 alongside one longitudinal edge of aperture 46 is bent slightly inwardly to form an engagement lip 48. Previously known strike plates have included a flange that extends inwardly along one longitudinal edge of an opening in the strike plate. However, these prior art flanges are not curved relative to the interior surface of the strike plate. They are, instead, straight, flat pieces of metal that are disposed at right angles to the interior surface of the prior art strike plates. The lip 48 of second member 36b is given a slight curvature so that a tip 48a (FIG. 5) thereof is complementary configured to valleys 38b, 38c, 38d, 38e of grooves 38. When first and second members 34, 36 are placed in abutting contact, as will be described hereinafter, tip 48a is received in one of the valleys of grooves 38 and thereby frictionally retains the first and second members together. Preferably, tip 48a extends for a distance of around 0.02 inches outwardly beyond interior surface 36b.

A pair of screw holes 50 is defined in second member 36 with each screw hole 50 being disposed on one or the other side of aperture 46. Screw holes 50 are positioned on second member 36 in such a location that they will be alignable with a region of slots 44 in first member 34 when the first and second members are engaged with each other. Screw holes 50 are configured to receive fasteners 32 therethrough but are small enough that the heads of those fasteners will not pass therethrough.

Strike plate assembly 24 is installed and used in the following manner. First member 34 is placed in mortise 26 such that interior surface 34b thereof abuts the wood of door jamb 12a and a region of each slot 44 aligns with one of the screw holes 30. Second member 36 is placed in contact with first member 34 in such a manner that interior surface 36b of second member 36 is in abutting contact with exterior surface 34a of first member 34. Additionally, tip 48a of lip 48 is positioned in one of the valleys of grooves 38 and aperture 46 is at least partially aligned with aperture 42 in first member 34. Fasteners 32 are then inserted through aligned holes 50, slots 44 and holes 30 and are screwed in until first and second members 34, 36 are loosely secured to door jamb 12a.

The installer will then rotate door 14 to a closed position to see how latch 22 aligns with the aligned apertures 46, 42 and mortise hole 28. FIG. 4 shows door 14 being of a first thickness T1 with one side 14 of door 14 engaging the door stop 12b on door jamb 12a. During installation, the installer is able to slide one or both of the first and second members 34, 36 toward or away from each other. The degree to which the first member is able to slide relative to the second is fairly large. The degree to which the second member is able to slide relative to the first is somewhat less. The direction of motion in both instances is disposed substantially at right angles to the longitudinal axis of the first member 34. In a first instance, first member 34 is moved either toward first end 28a of mortise hole 28 or toward second end 28b thereof until there is a sufficiently wide enough space defined by the aligned apertures 46, 42 that will permit latch 22 to be received therethrough and into mortise hole 28. The aligned apertures 46, 42 define a strike hole through which latch 22 is received. Preferably, once latch 22 is received therethrough, the installer will slide first member 34 back toward first end 28a until flange 40 abuts latch 22 as illustrated in FIG. 4. This movement reduces the width of the strike hole and sets it in a particular position relative to the top edge 36c, bottom edge 36d, and left and right side edges 36e, 36f. When second member 36 is in this position, tip 48a of 48 is received in a valley 38c of grooves 38, thus retaining first and second members 34, 36 in a frictional interlocking engagement with each other. The fasteners 32 are then rotated to secure strike plate assembly 24 to door jamb 12a. As illustrated in FIGS. 4 & 5, the strike hole where latch 22 is positioned is disposed generally midway between first and second ends 28a, 28b of mortise hole 28. Flange 40 not only guides latch 22 toward mortise hole 28 but also aids in preventing door 14 from being kicked open as it provides a support against which latch 22 will rest if there is an attempt to rotate the door to an open position when it is latched or locked to door frame 12. Flange 40 therefore assists in keeping door 14 securely locked or latched to frame 12 in that it substantially prevents lateral movement of latch 22.

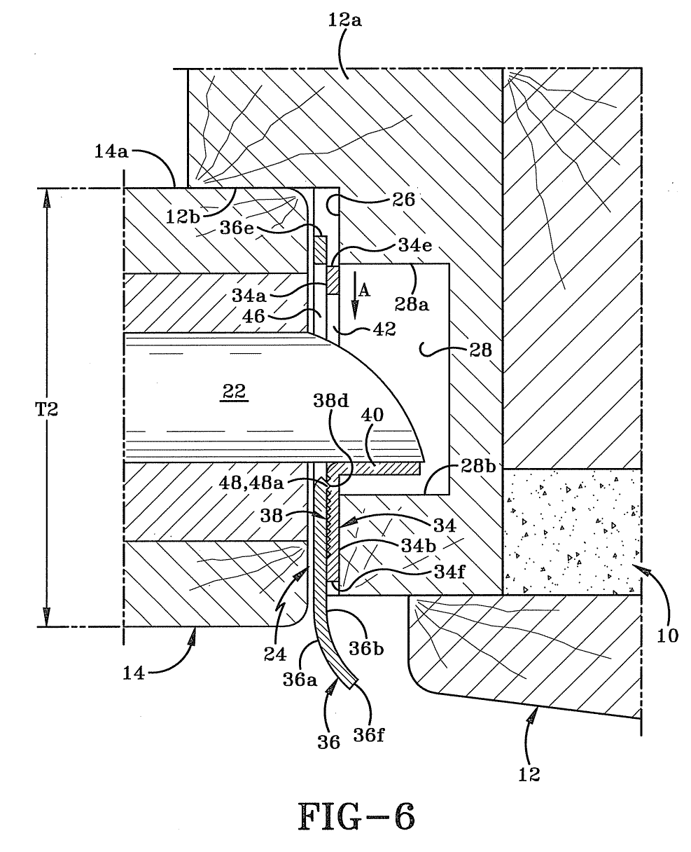

If, door 14 is of a thickness T2, as illustrated in FIG. 6, then the door will extend for a distance beyond the side of door jamb 12b. If first and second members 34, 36 were kept in the same place as shown in FIG. 5 with this thicker door, then latch 22 will contact a portion of first member 34 and will thereby be prevented from entering mortise hole 28. Obviously, this will prevent door 14 from latching or locking to door frame 12. In this instance, the installer is able to adjust strike plate assembly 24 to effectively relocate the strike hole through which latch 22 extends in order to successfully insert latch 22 in mortise hole 28. This adjustment is accomplished by sliding first member 34 towards second end 28b of mortise hole 28 in the direction of arrow “A” when fasteners 32 are loosely holding first and second members 34, 36 to door jamb 12a. The installer can insert the end of a screwdriver through apertures 46, 42 to push first member 34 in this direction. The installer may need to slightly separate second member 36 from first member 34 to make this happen. The motion causes tip 48a of lip 48 to disengage from the valley 38c so that the first and second members 34, 36 can move relative to each other. First member 34 is slid downwardly in the direction of arrow “A” until a sufficiently large enough strike hole is created between the overlapping and aligned apertures 46, 42 to allow latch 22 to pass through the same and into mortise hole 28. The installer will then slide first member 34 in the opposite direction to arrow “A” until flange 40 abuts latch 22. Second member 36 is then pushed inwardly toward first member 34 in a direction disposed at right angles to the exterior surface 36a of second member. This motion causes tip 48a of lip 48 to be received within a second valley 38d positioned a distance from valley 38c. First and second members 34, 36 frictionally interlocking engage each other by way of the interlocking lip 48 and valley 38d and then fasteners 32 are rotated to secure first and second members 34, 36 to door jamb 12a. Once again, the dimensions, specifically the width, of the strike hole are set according to the width of the latch 22. The relative position of the strike hole on the strike plate assembly is also shifted closer toward the lip end of the second aperture 46 than was the case with the narrower door shown in FIG. 5.

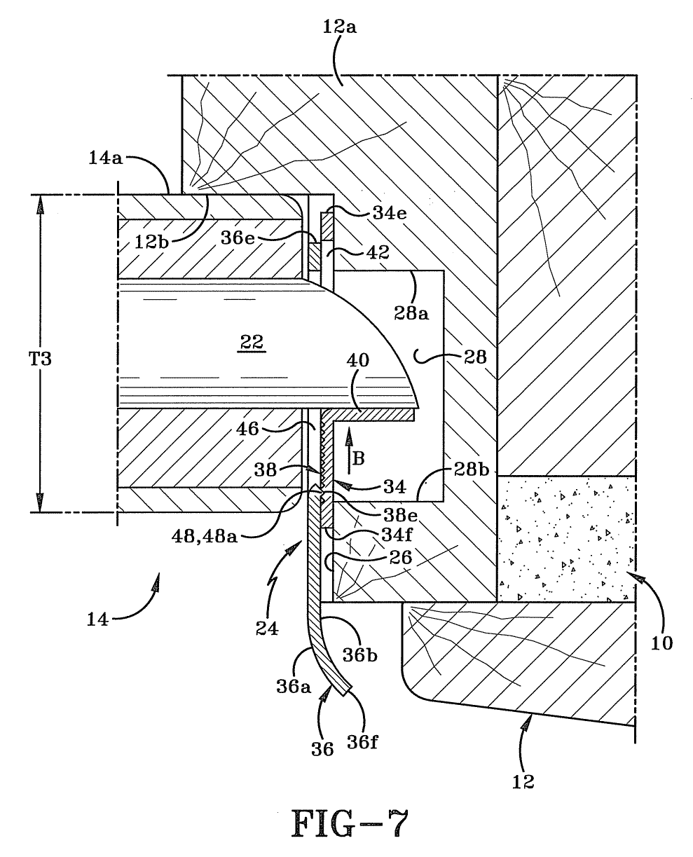

Finally, FIG. 7 shows a situation where door 14 has a thickness T3 that is smaller than either of thicknesses T1 and T2. Thus, the door is disposed a short distance inwardly from the edge of door jamb 12a. In this instance, one or both of the first and second members 34, 36 is slid in the direction of arrow “B” so that the strike hole through which the latch 22 is to be received migrates away from second end 28b of mortise 28 and toward first end 28a thereof. When the strike hole defined by the aligned apertures 46, 42 is such that latch 22 is receivable therethrough and into mortise hole 28, first member 34 is slid in the direction of arrow “B” until flange 40 is in a position to abut latch 22. At this point, tip 48a of lip 48 is received in valley 38e of grooves 38 and first and second members 34, 36 are frictionally engaged together. Fasteners 32 are then rotated to secure first and second members 34, 36 to door jamb 12a. Once again, the dimensions of the strike hole are dictated by the latch 22 and the relative positions of the first and second members and the position of the strike hole relative to the lip end of the second aperture 36 is changed yet again. In this third instance, the strike hole is positioned remote from the lip end of the aperture and is closer to the side of the second aperture opposed to the lip end.

While the majority of the adjustment between the first and second members 34, 36 occurs through movement of the first member 34, it is possible for the second member 36 to be moved relative to the first member 34 in order to change the dimensions of the strike hole and the position thereof relative to the lip end of the second aperture.

It should be understood that part of the reason why first member 34 and second member 36 are movable relative to each other is because of the presence of elongated slots 44 in first member. The degree of relative movement is obviously restricted by the size of the elongated aperture in first member 34. The orientation of the elongation as illustrated provides for a side to side adjustment in the size and position of the space created by the overlapping of apertures 46 and 42 through which latch 22 may extend. It will be understood that if slots 44 were elongated in a direction so as to align the elongation with the longitudinal axis of the first member 34, then the height of the space and the vertical position of the space on strike plate assembly 24 could be adjusted. It could be possible to provide an X-shaped or +-shaped slot to permit adjustment in one or both directions or to provide other shaped slots that will provide other directions of adjustment of the first and second members of the strike plate assembly 24. Additionally, the strike plate assembly 24 could include a third member that is substantially identical to the first member except for the orientation of the elongation of the slots 44. This would permit the installer to select the appropriate one of the first and third members to engage with the second member of the strike plate assembly.

It should be noted that because one or both of the first and second members 34, 36 is movable relative to the other, strike plate assembly 24 is useful for correctly positioning the strike hole for a wide variety of different manufacturer's handsets and for different thickness doors or other circumstances that cause misalignment between the latch and mortise hole. Additionally, the device is easily adjusted by simply loosening the two fasteners 32 only to a degree sufficient to permit the small tip 48a of the second member 36 from disengaging from the grooves on the first member 34.

It will be understood that it is also contemplated that the grooves and tip could be omitted and the strike plate assembly simply comprise two members that are slidable in opposite directions to adjust the position of the strike hole. (The term strike hole is used to define the space between the aligned apertures 46, 42 in the two members that permits the latch 22 to pass therethrough and into the mortise hole 28.) It is further contemplated that mechanisms other than the interlocking groove and lip could be used for holding the first and second members in their relative positions prior to rotation of the fasteners to secure the strike plate assembly to the door jamb.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. An adjustable strike plate assembly for a door, comprising:
a first member having an interior surface adapted to abut a door frame, an exterior surface opposed to the interior surface, a top edge, a bottom edge, a left side edge and a right side edge;
a second member having an interior surface disposed in abutting contact with the exterior surface of the first member; said second member further including an exterior surface opposed to the interior surface thereof;
a first aperture defined in the first member and extending between the interior and exterior surfaces thereof; said first aperture being spaced a distance inwardly from each of the top, bottom, left side and right side edges; and wherein said first aperture is adapted to at least partially align with a mortise hole in the door frame;
a second aperture defined in the second member and extending between the interior and exterior surfaces thereof, said second aperture being selectively alignable with at least a portion of the first aperture so as to define a strike hole which is adapted to receive a latch or bolt therethrough when the door is closed; and wherein the first member is movable relative to the second member to change the dimensions and location of the strike hole.

2. The strike plate assembly as defined in claim 1, wherein the first member includes a longitudinal axis that extends between the top and bottom edges thereof; and wherein the first member is movable in a direction that is disposed generally at right angles to the longitudinal axis.

3. The strike plate assembly as defined in claim 1, wherein the first member is free of curves along its left side and right side edges.

4. The strike plate assembly as defined in claim 1, wherein the first member further includes:
a flange extending outwardly away from the interior surface thereof and adapted to be received within the mortise hole when the strike plate assembly is secured to the door jamb.

5. The strike plate assembly as defined in claim 4, wherein said flange is provided on a portion of the first member disposed immediately adjacent a side of the first aperture.

6. The strike plate assembly as defined in claim 4, wherein the flange is disposed a distance inwardly away from both of the left side and right side edges of the first member.

7. The strike plate assembly as defined in claim 4, wherein the flange is disposed at right angles to the interior surface of the first member.

8. The strike plate assembly as defined in claim 4, wherein the flange is disposed substantially parallel to the longitudinal axis of the first member.

9. The strike plate assembly as defined in claim 1, further comprising:
a pair of elongated slots defined in the first member, a first one of the slots being provided between the aperture and the top edge of the first member, and a second one of the slots being provided between the aperture and the bottom edge of the first member.

10. The strike plate assembly as defined in claim 9, wherein a region of the first member surrounding each of the slots is smooth and free of grooves.

11. The strike plate assembly as defined in claim 1, wherein the first member is rectangular in shape.

12. The strike plate assembly as defined in claim 1, wherein the second member is substantially planar and includes a top edge, a bottom edge, a left side edge and a right side edge.

13. The strike plate assembly as defined in claim 12, wherein one of the left side and right side edges is curved when viewed from above and the other of the left side and right side edges is straight when viewed from above.

14. The strike plate assembly as defined in claim 12, wherein the second aperture is defined a distance inwardly from each of the top, bottom, left side and right side edges.

15. The strike plate assembly as defined in claim 1, wherein both of the interior and exterior surfaces of the second member are smooth and free of grooves.

16. The strike plate assembly as defined in claim 1, further comprising a lip extending outwardly away from the interior surface of the second member.

17. The strike plate assembly as defined in claim 16, wherein said lip is provided on a portion of the second member disposed immediately adjacent a side of the second aperture.

18. The strike plate assembly as defined in claim 17, wherein the lip is disposed a distance inwardly away from both of the left side and right side edges of the second member.

19. The strike plate assembly as defined in claim 17, wherein the lip is curved relative to the exterior surface of the second member.

20. The strike plate assembly as defined in claim 19, further comprising:
a tip provided at an end of the lip; said tip extending for a distance beyond the interior surface of the second member; and
at least a first groove and a second groove provided on the exterior surface of the first member; and wherein the tip of the lip is selectively engageable in one of the first and second grooves.

21. The strike plate assembly as defined in claim 17, wherein the lip is disposed substantially parallel to the longitudinal axis of the first member and extends for a distance of less than a length of the side of the second aperture immediately adjacent thereto.

22. The strike plate assembly as defined in claim 14, further comprising a first screw hole and a second screw hole defined in the second member, and wherein the first screw hole is defined in a region of the second member between the top edge thereof and the second aperture, and the second screw hole is defined in a region of the second member between the bottom edge thereof and the second aperture; and
a first and a second elongated slot are defined in the first member in positions that will align with the first and second screw holes when the interior surface of the second member is placed in abutting contact with the exterior surface of the first member.
